(19) United States
(12) Patent Application Publication
(10) Pub. No.: US 2008/0050469 A1
(43) Pub. Date: Feb. 28, 2008

(54) Jumping window based fast pattern matching method with sequential partial matches using TCAM

(75) Inventors: Taeck-Geun Kwon, Youseong-Gu (KR); Seok-Min Kang, Youseong-Gu (KR); Il-Seop Song, Youseong-Gu (KR)

Correspondence Address: THE WEBB LAW FIRM, P.C., 700 KOPPERS BUILDING, 436 SEVENTH AVENUE, PITTSBURGH, PA, 15219, US

(73) Assignee: The Industry & Academic Cooperation in Chungnam National University, Youseong-gu (KR)

(21) Appl. No.: 11/508,474

(22) Filed: Aug. 23, 2006

(51) Int. Cl. A21D 2/24

(52) U.S. Cl. 426/23

(57) ABSTRACT

A jumping window based fast pattern matching method using TCAM includes TCAM entries containing all possible sub-patterns independent of position. Due to these sub-patterns, the method can search for all patterns appearing within the window at once. If a match is not found, the method jumps to the next window (shift size of M bytes), opposed to the sliding window method that shifts to the next byte (shift size of 1 byte). This incurs a pattern match that is M times faster, despite requiring a larger TCAM size to be able to represent all possible redundant sub-patterns in the TCAM; here, M is the size of a jumping window. In addition, the present invention employs a two-phase pattern matching sequence for a large number of long patterns such as virus and worm signatures. In the first phase, the fixed prefix will be searched with TCAM; then, only the CRC value for the remaining pattern is examined to confirm the existence of the entire pattern. Since the TCAM only stores the prefixes of the patterns instead of storing entire long patterns, a smaller TCAM size is sufficient to match the large number of long patterns at link-speed of the high-speed Internet.

### BACKGROUND OF THE INVENTION

1. Technical Field

The present invention relates generally to a pattern matching method for packet contents and, more particularly, to a method for detecting virus and worm signatures in networks by classifying packets accurately with deep inspection of the packet payload; the invention enables intrusion and virus/worm detections to prevent these threats in high-speed networks.

2. Background Art

The advancement of technology is enabling the continued growth of 10 Gbps(Gigabit per second) networks on the Internet. Although intrusion detection systems(IDSs) have been applied to low-speed networks, the threats of worms and viruses have increased significantly, making it is necessary to protect the core network from these threats. Several researches, including reference [F. Yu, R. H. Katz, T. V. Lakshman, “Gigabit Rate Packet Pattern-Matching Using TCAM,” International Conference on Network Protocols (ICNP), 2004.], focus on implementing high-speed IDSs. The present invention combines the architecture of high-performance IDSs with efficient deep packet inspection algorithms using Ternary Content Addressable Memory(TCAM).

However, traditional methods of pattern matching cannot support the speed of the Internet backbone even if they have employed TCAM technology, due to the large number of TCAM accesses that are required. For deep packet inspections at line-speed, TCAM is the major bottleneck device. Thus, further developing TCAM technology will alleviate serious security concerns and reduce the number of viruses/worms spreading through the high-speed Internet.

### DISCLOSURE OF THE INVENTION

Accordingly, the present invention addresses the problems mentioned in the prior art, and an objective of the present invention is to provide higher speed deep packet inspections with TCAM, which is to detect patterns among the content of packets. In order to speed up the process of pattern matching, all possible sub-patterns need to be stored in the TCAM independent of the position and state information, to trace the sequence of partial matches. For the state information, the present invention employs a unique identification number which distinguishes other partial match conditions at the different states.

In addition, the present invention considers a large number of long patterns which commonly describe virus and worm signatures. Since the size of TCAM is limited, only the prefix of the long pattern is stored in the TCAM; if the prefix is matched using TCAM, the Cyclic Redundancy Code (CRC) will be calculated to check if there is a match for the suffix. The CRC value and the prefix associated data are examined to verify whether a match for the searched pattern has been found.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the basic operation of pattern matching using TCAM;

FIGS. 2-4 are diagrams showing the process of pattern matching using traditional methods;

FIG. 5 is a graph showing the required performance of the TCAM, in terms of Million Searches per Second (MSPS);

FIGS. 6-8 are diagrams showing the process of pattern matching using the present invention, the jumping window based pattern matching method;

FIG. 9 is a diagram showing the relationship between partial matches for consecutive sub-patterns;

FIG. 10 is a diagram showing state transitions for partial matches for consecutive sub-patterns from FIG. 9;

FIG. 11 is a diagram showing the structure of TCAM from FIGS. 6-8;

FIG. 12 is a graph showing the relationship between the jumping window size and TCAM accesses/size;

FIG. 13 contains graphs plotting pattern length distributions for two applications; (a) shows the distribution for Snort, an IDS, and (b) shows the distribution for ClamAV, a virus/worm detection system;

FIG. 14 is a diagram showing a two-phase pattern matching method for long patterns using TCAM and CRC; and

FIGS. 15(a)-(c) are diagrams showing the process of CRC calculations for the pattern suffix.

### BEST MODE FOR CARRYING OUT THE INVENTION

Reference should now be made to the drawings, in which the same reference numerals are used throughout the different drawings to designate identical or similar components.

### Embodiments of the present invention are described in detail below.

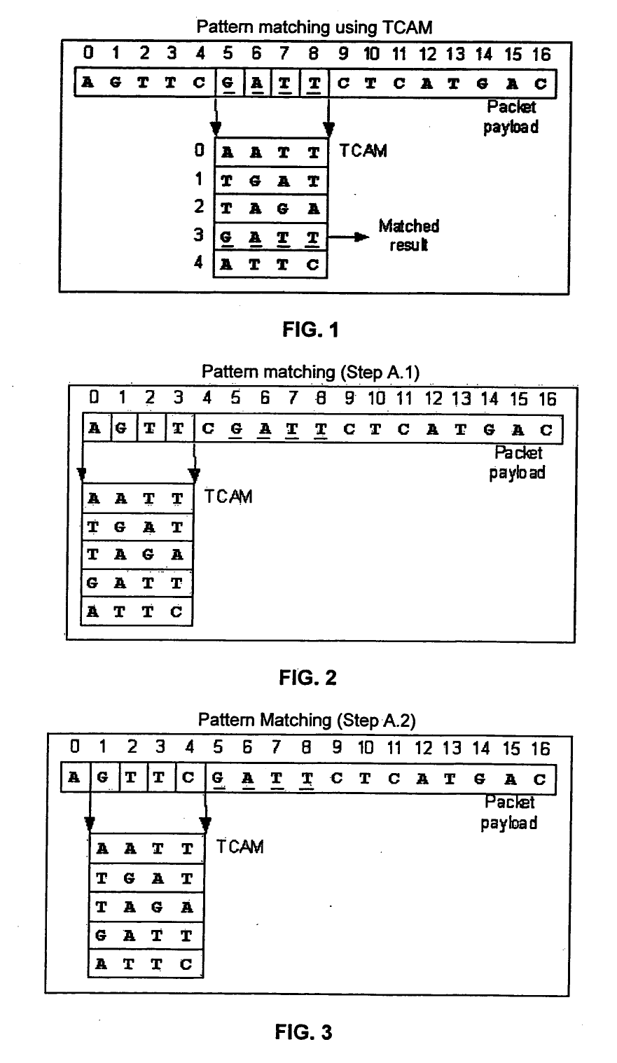

FIG. 1 illustrates the basic operation of pattern matching using TCAM under the assumption that the TCAM entry size is 4. The TCAM returns a matched result if one of the entries “AATT”, “TGAT”, “TAGA”, “GATT”, or “ATTC” is found. Since the pattern “GATT” is located from position 5 to position 8 in the packet payload, the TCAM should return matched results associated with the entry “GATT”.

An expected pattern can appear in arbitrary positions in the packet payload, thus all possible ranges should be examined: for instance, position 0˜3, position 1˜4, position 2˜5, and so forth. FIG. 2 shows the first attempt, i.e., Step A. 1, to match “GATT” in the packet payload.

If Step A.1 could not match the pattern “GATT”, the next possible range, i.e., position 1˜4, should be examined. This is because the pattern may appear at any position. FIG. 3 shows the next step, i.e., Step A.2.

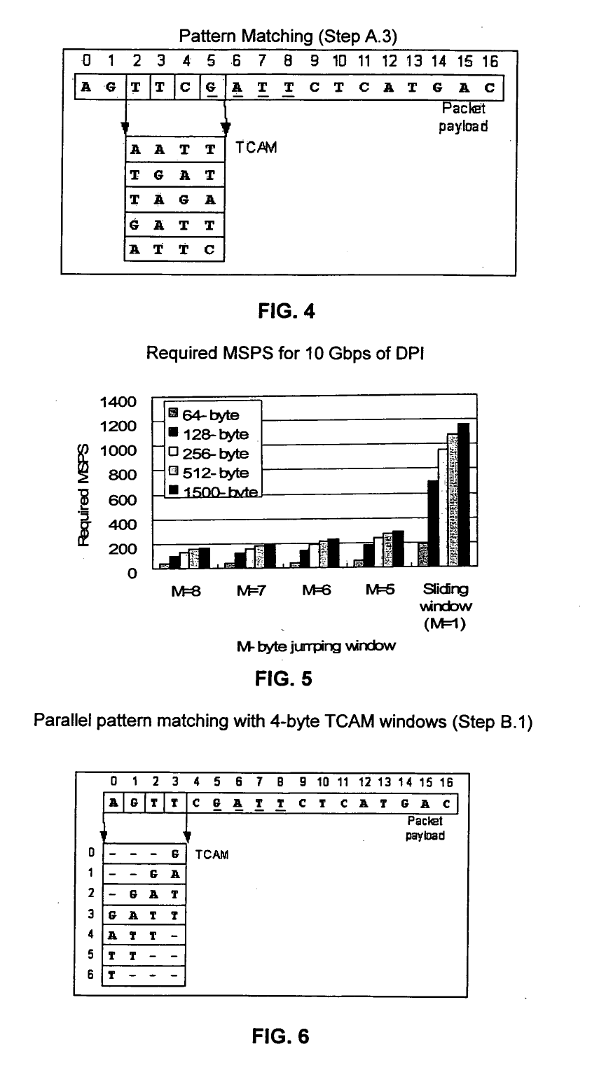

In addition, FIG. 4 shows the next attempt to match the pattern. Intuitively, this method requires lots of TCAM accesses to find a pattern in the packet payload. If the access latency of the TCAM is fixed, the performance of deep packet inspection is highly dependent on that of the TCAM. This approach to DPI(Deep Packet Inspection) is the sliding-window method; it shifts one-byte at a time to search the pattern.

For example, a 10 gigabit Ethernet (GbE) delivers packets at a rate of approximately 1 GB(Giga-Byte)/sec; this means a 10 GbE requires about one billion TCAM accesses per second. However, this rate varies depending on the packet size being delivered. Current TCAM supports 250 MSPS (million searches per second). FIG. 5 shows the required MSPS for a 10 GbE, where M denotes the number of bytes shifted for each pattern match. Increasing the jumping window size, M, reduces number of required TCAM accesses, i.e., requires a smaller rate of MSPS. In general, the larger packets require more TCAM accesses than the smaller packets, and they also require more MSPS for achieving 10 Gbps of DPI as shown in FIG. 5.

In order to increase the performance of DPI, the TCAM manages all possible sub-patterns independent of the position the pattern may appear in. For example, since pattern “GATT” can appear at position 0, 1, 2, . . . , the TCAM manages “---G”, “--GA”, “-GAT”, and “GATT”. The sub-patterns can start at positions 3, 2, 1, and 0, respectively. In addition, the remaining sub-patterns, i.e., “ATT”, “TT”, and “T”, can also appear within the range. FIG. 6 shows parallel pattern matching with 4-byte TCAM windows. The TCAM manages 7 entries for a single pattern, “GATT”. Instead of shifting one byte at a time, this M-byte jumping window method examines all possible cases that may appear at any position within the M-byte window.

Contrary to the sliding window method, the M-byte jumping window method starts to examine the next Mth byte in the next step. FIG. 7 shows the next step for this parallel pattern matching method. As shown, the sub-pattern “-GAT” is matched and the TCAM returns the associated matched result.

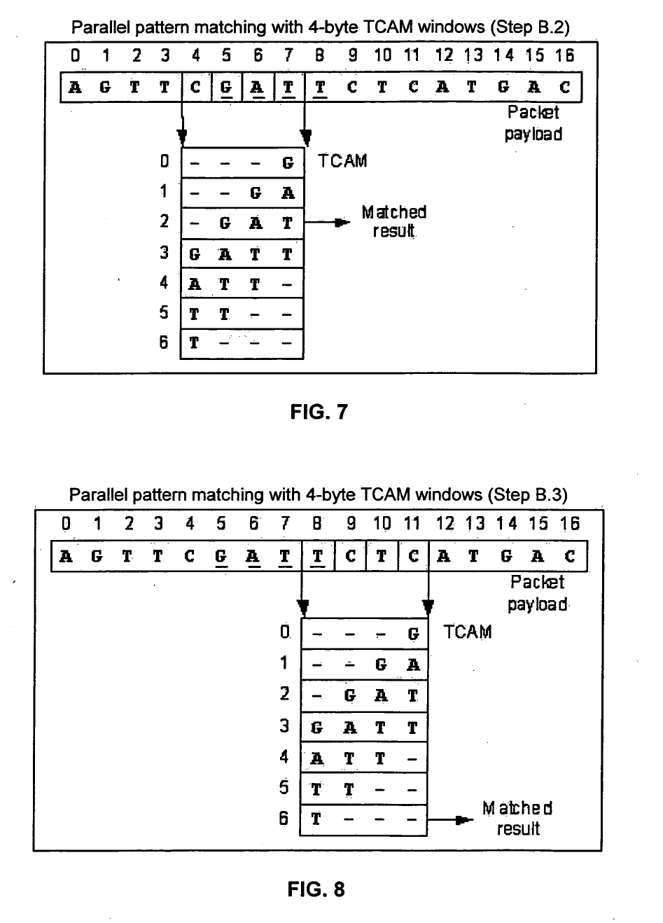

### In the same manner, Step B.3 returns the matched results as shown in FIG. 8.

In Steps B.2 and B.3, “-GAT” and “T---” are matched for pattern “GATT”. In order for the match to be successful, the remaining sub-pattern must be a specific match to the previous sub-pattern so that concatenating the two sub-patterns will result in the pattern that is being searched for, “GATT” in this case. As illustrated in FIG. 9, sub-patterns “---G”, “--GA”, and “-GAT” are related to sub-patterns “ATT-”, “TT--”, and “T---”, respectively. For example, both sub-patterns “-GAT” and “T---” must be matched consecutively in order to match pattern “GATT” in the packet payload.

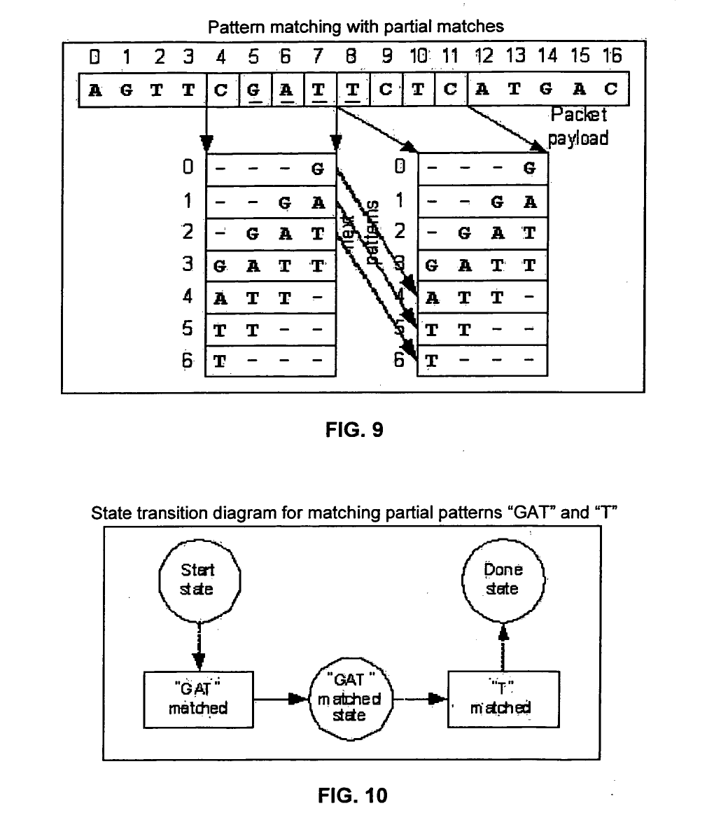

FIG. 10 summarizes how to match pattern “GATT” by matching partial patterns “GAT” and “T” in a state transition diagram. First, sub-pattern “GAT” is matched and the state goes to the “GAT” matched state. In the “GAT” matched state, the remaining sub-pattern “T” must be matched in order for the pattern match to be successfully completed.

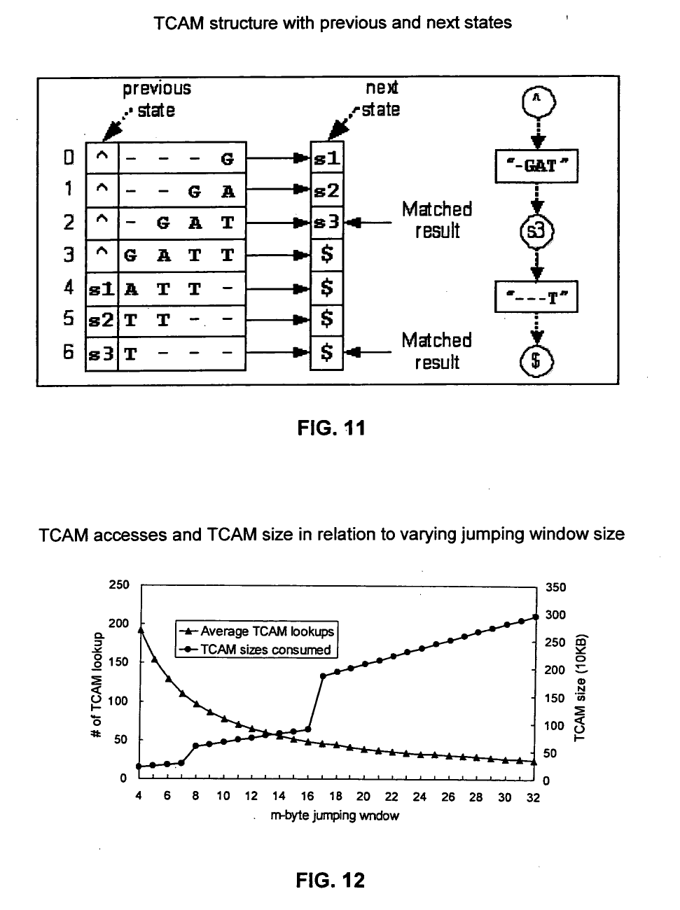

FIG. 11 shows the TCAM structure in detail. The TCAM entry consists of previous states and sub-patterns along with next states for the associated data. If sub-pattern “GAT” is matched to the starting state, denoted by symbol (̂), the state transits into state ‘s3’. For the next consecutive sub-pattern “T”, state ‘s3’ should be used. The second match result shown in the figure denotes the successful completion of pattern matching, shown as symbol ($).

Unlike the sliding window method, the M-byte jumping window method for DPI using TCAM should manage some redundant sub-pattern information, including state information. FIG. 12 plots the relationship between the jumping window size, M (independent variable), and the required number of TCAM accesses and TCAM size (dependent variables); these are represented as two separate plots on the same graph. Since the current TCAM supports window sizes such as 36, 72, 144, and 288 bits, the TCAM size increment resembles a set of “increasing stairs” as shown. The average number of TCAM lookups, however, decreases as the jumping window size increases.

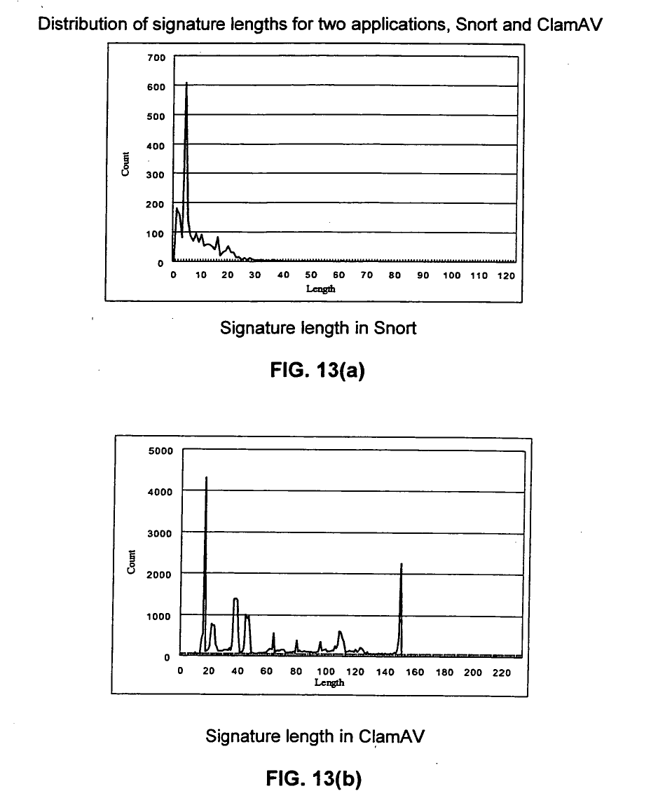

The M-byte jumping window method consumes more TCAM memory than the original sliding window method. The length of signatures for virus and worm pattern detection applications such as ClamAV is quite long, whereas the length of signatures for intrusion detection and prevention applications such as Snort[ClamAV, Clam Anti-virus, http://www.clamav.net/] is relatively short. FIG. 13 shows two signature length distribution graphs: (a) shows the signature length distribution for Snort, an IDS(Intrusion Detection System) application, and (b) shows the signature length distribution provided by ClamAV[ClamAV, Clam Anti-virus, http://www.clamav.net/], an anti-virus application. Since the TCAM size is limited, for instance to 9 Mbits, a large number of long signatures cannot be stored in the TCAM. In addition, the number of virus and worm signatures is increasing daily.

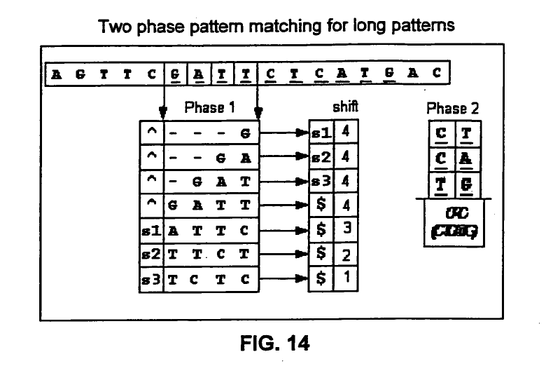

In order to match long patterns using TCAM, we invent a two-phase pattern matching method. In phase 1, our scheme matches only the prefix of the pattern but not the entire pattern. In phase 2, the remaining pattern, i.e., the suffix of the original pattern, is examined sequentially. To reduce the amount of information stored for the associated data, only the CRC (Cyclic Redundancy Code) value is kept for phase 2. FIG. 14 shows an overview of long pattern matching; in this example, we assume that the long pattern is “GATTCTCATG”. For two-phase pattern matching, the pattern will be split into two parts, “GATT” and “CTCATG”: the prefix and suffix of the pattern, respectively. If the prefix has been matched using TCAM, the CRC value for the remaining sub-pattern can be calculated; this value is denoted ‘CRC(CTCATG)’.

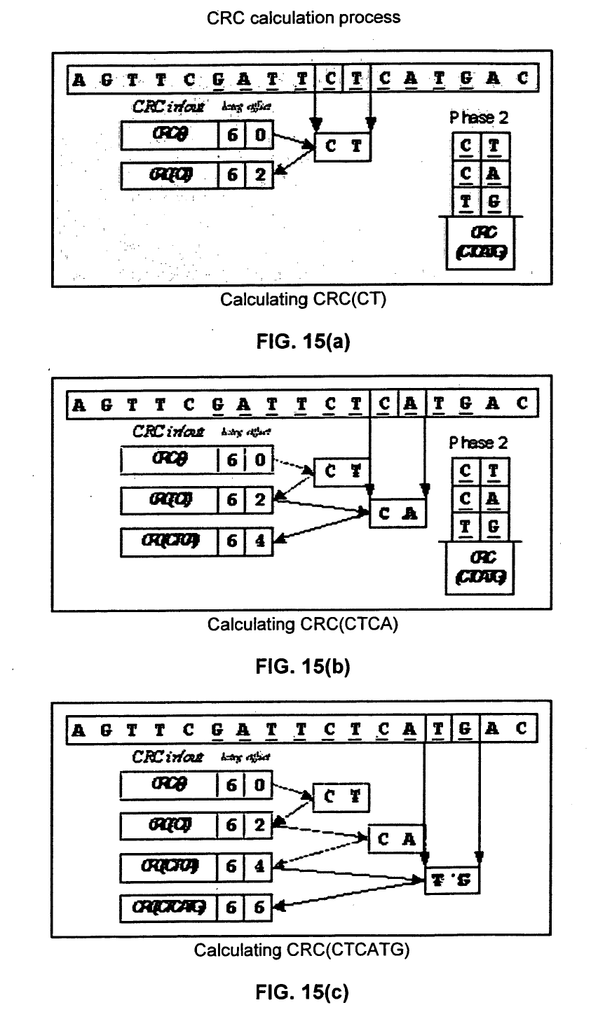

Assuming the CRC value can be sequentially calculated two bytes at a time, the process of CRC calculation for the suffix of the pattern is shown in FIG. 15, where field ‘leng’ represents the suffix length and field ‘offset’ represents the current position of the suffix. CRC calculations continue until ‘offset’ equals ‘leng’. Upon finishing the CRC calculation for the suffix, the CRC value and the expected CRC value (not shown) are equal only when the pattern appears in the packet payload.

1. A fast method of pattern matching using TCAM, comprising of:
a method to represent all possible sub-patterns to match the pattern independent of the position that the pattern appears in;
a method to jump to the next window for matching the next sub-patterns using TCAM;
a method to represent state information with a unique identifier in order to manage the series of sub-pattern matches in the sequence; and
a method to make search keys for TCAM entries by concatenating both state information and sub-pattern.

2. A method of pattern matching for a large number of long patterns, comprising of:
a method to split long patterns into the prefix and the suffix of the pattern, and to match the prefix using TCAM and to match the suffix using the CRC value; and
a method to fix the starting suffix using ‘shift’ values in the associated data, as shown in FIG. 14.
